(19) United States
(12) Patent Application Publication
(10) Pub. No.: US 2007/0158030 A1
(43) Pub. Date: Jul. 12, 2007

(54) Hands free tape dispenser

(76) Inventor: Mario Kyriacou, New Port Richey, FL (US)

Correspondence Address: LARSON AND LARSON, 11199 69TH STREET NORTH, LARGO, FL, 33773, US

(21) Appl. No.: 11/330,670

(22) Filed: Jan. 12, 2006

(51) Int. Cl. B44C 7/00; B65D 85/00; F42B 39/02

(52) U.S. Cl. 156/577; 156/579; 206/411; 221/185

(57) ABSTRACT

A tape dispenser is wearable on a forearm and includes a hub for holding a supply roll of tape. The dispenser is shaped to fit over the forearm and has clips or straps to removably hold it in place on the forearm. Optionally, a finger grip provides additional leverage and a sharp cutting edge enables easy cutting of the tape.

### BACKGROUND OF THE INVENTION

1. Field of the Invention

This invention relates to the field of applying tape from a roll of tape and more particularly to a device for applying tape while permitting use of one's hands for other activities.

2. Description of the Related Art

For many, regular application of various types of tape is performed on a routine basis. Painters apply masking tape to trim in a house or windows and non-painted surfaces of automobiles before applying paint. Packagers and postal workers apply packing tape to boxes to seal them before shipping.

Tape applicators and dispensers are known in the art. They often help by holding the roll of tape and providing a cutting surface, but most require one or two hands to operate, requiring the user to remove both hands from the object being taped. The simplest is a tape dispenser such as the dispenser shown in U.S. Des. Pat. No. 510,951 to Carlson, et al. This dispenser provides a spool for holding a roll of tape and a cutting edge so that the amount of tape required can be pulled off the roll and cut by the cutting edge. Generally, this device requires one hand to hold the dispenser in a stationary position and the other hand to pull the tape. Similar dispensers have been devised with heavy bases allowing the dispenser to remain relatively stable as the tape is pulled and cut with only one hand.

Other applicators/dispensers are designed for one-hand operation. Examples include U.S. Pat. No. 3,170,613 to Casey, U.S. Pat. No. 3,567,557 to Kingery et al, U.S. Pat. No. 3,969,160 to Ravelsloot, and U.S. Pat. No. 4,915,768 to Soderferg. In particular, the '768 patent includes a hand-held device with a spool for holding the roll of tape and a cutting edge. This device lets the user place the tape on the target item (e.g., a box to be sealed) and a roller guides the tape along the target item, dispensing tape until the user pulls the tape across a cutting surface to cut the tape. This device frees the user's second hand to hold the target item closed or in place while the tape is being applied. Unfortunately, as is often the case, the tape dispenser is situated some distance from the target item (or lost) and the user must let go of the target item, retrieve the tape dispenser, reposition the target item and apply the tape.

One solution to this problem is presented in U.S. Pat. No. 6,085,955 to Hicks, et al. This patent describes a tape dispenser that is worn on the wrist, thereby making it more accessible and easier to find. Even though this dispenser allows the use of one hand to hold the target item, the second hand is still required to pull the tape from the dispenser. Furthermore, both hands must be in close proximity so that the second hand can pull the tape from this dispenser. This would not be beneficial in a situation where one hand is holding a package whereby the user cannot see the dispenser or the second hand cannot easily reach the tape within the dispenser.

Another solution is described in U.S. Pat. No. 3,993,230 to Oakes includes a tape dispenser with finger grip openings so the tape dispenser can be worn on one or more fingers. This dispenser still requires the second hand to pull the tape.

What is needed is a dispenser that will provide for single handed dispensing of tape.

### SUMMARY OF THE INVENTION

One objective of the present invention is to provide a tape dispenser that can be worn, allowing single-handed dispensing while not significantly impeding the use of the hand upon which it is worn.

In one embodiment, a forearm-mountable tape dispenser is disclosed including a tape holder having a base portion shaped to conform to a person's forearm and thereby supporting the tape holder. The base portion has a tape dispensing mechanism for dispensing tape that includes a hub rotatably adapted to the tape holder for holding a supply roll and the tape dispensing mechanism with a guide for delivering the tape from the supply roll to a front peripheral edge of the tape holder. There is a way to removably secure the tape holder to the forearm.

In another embodiment, a device for dispensing tape is disclosed including a base shaped to conform to an upper surface of a human forearm. Rotatably coupled to the base is a hub for holding a supply roll of tape. A guide is situated along the top surface of the base for delivering the tape from the supply roll to a front peripheral edge of the base. At least one set of straps are affixed to opposite sides of the base to allow the device to be removably strapped to the human forearm.

In another embodiment, a device for dispensing tape is disclosed including a base with a hub rotatably coupled to it for holding a supply roll of tape. A guide system on a top surface of the base is adapted to transport the tape from the supply roll to a front peripheral edge of the base. There is a mechanism for removably securing the base to a human forearm.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a perspective view of a first embodiment of the present invention.

FIG. 2 illustrates a perspective view of a second embodiment of the present invention.

FIG. 3a and FIG. 3b illustrate a perspective detail view of the spool of both embodiment of the present invention.

FIG. 4 illustrates a sectional view of the spool of both embodiment of the present invention.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures. The term “tape” is used to indicate a relatively flat material having one or both sides coated with a sticky material. Examples of tape are mending tape, packing tape, electrical tape and masking tape.

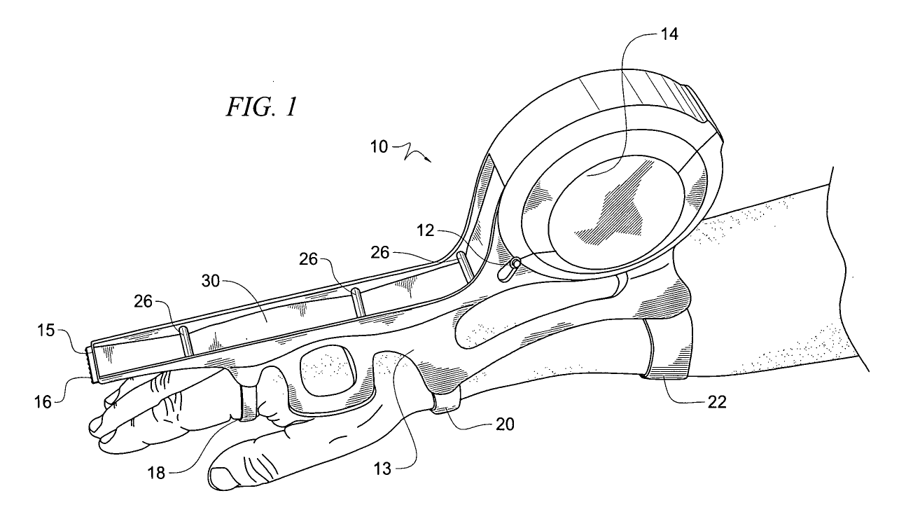

Referring to FIG. 1, a perspective view of a first embodiment of the present invention is shown. The dispenser 10 has a base 13 shaped in the general contour of an average human forearm. The dispenser is held in place on a users forearm by one or more bendable, resilient clips 20/22. These clips are open on the bottom and bend slightly to allow the user to insert a forearm, then restore, holding the dispenser 10 in place on the forearm. In one embodiment, an optional finger ring 18 is provided to provide extra strength and leverage. The optional finger ring 18 allows one or more fingers to provide frontal leverage while the tape 30 is being dispensed. The tape 30 is stored on a supply roll (not visible) behind a door 14 and is threaded under guides 26 to the front peripheral edge 15 of the base 13. A spring-loaded latch 12 holds the door 14 shut. In the preferred embodiment, a cutting edge 16 is provided on the front peripheral edge of the tape dispenser 10 to cut the tape 30 after sufficient amounts are dispensed. In some embodiments where the tape is easily torn, the separate cutting edge 16 is omitted. In some embodiments, the door 14 and latch 12 are omitted and the supply spool (not visible) is left exposed.

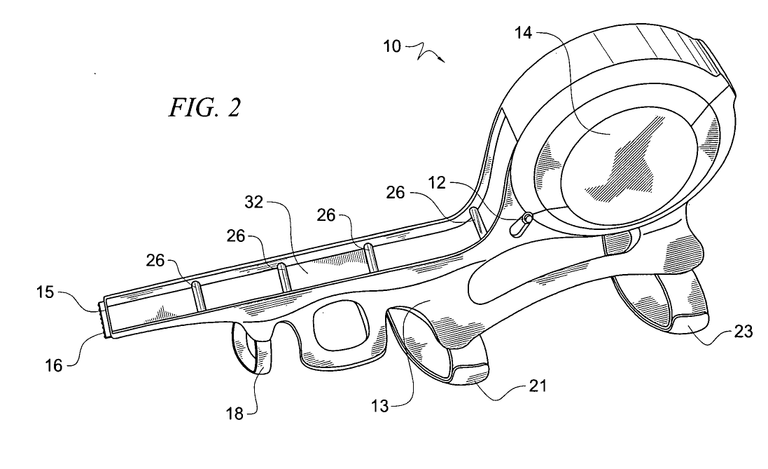

Referring now to FIG. 2, a perspective view of a second embodiment of the present invention is shown. In this view, the tape 30 (not visible) is not loaded. The dispenser 10 has a base 13 shaped in the general contour of an average human forearm. In this embodiment, the dispenser is held in place on a users forearm by one or more straps 21/23. These straps open to allow the user to insert a forearm, then close, holding the dispenser 10 in place on the forearm. The straps are held closed in any way known to bind straps including hook and loops (Velcro), snaps, buckles and simple knots and can easily be removed. In one embodiment, an optional finger ring 18 is provided to provide extra strength and leverage. The optional finger ring 18 allows one or more fingers to provide frontal leverage while the tape (not shown) is being dispensed. The tape (not shown) is stored on a supply roll (not visible) behind a door 14 and is threaded between guides 26 and the bottom of the trough 32 to the front peripheral edge 15 of the base 13. A spring-loaded latch 12 holds the door 14 shut. In the preferred embodiment, a cutting edge 16 is provided to cut the tape 30 after sufficient amounts are dispensed. In some embodiments, the door 14 and latch 12 are omitted and the supply spool (not visible) is left exposed.

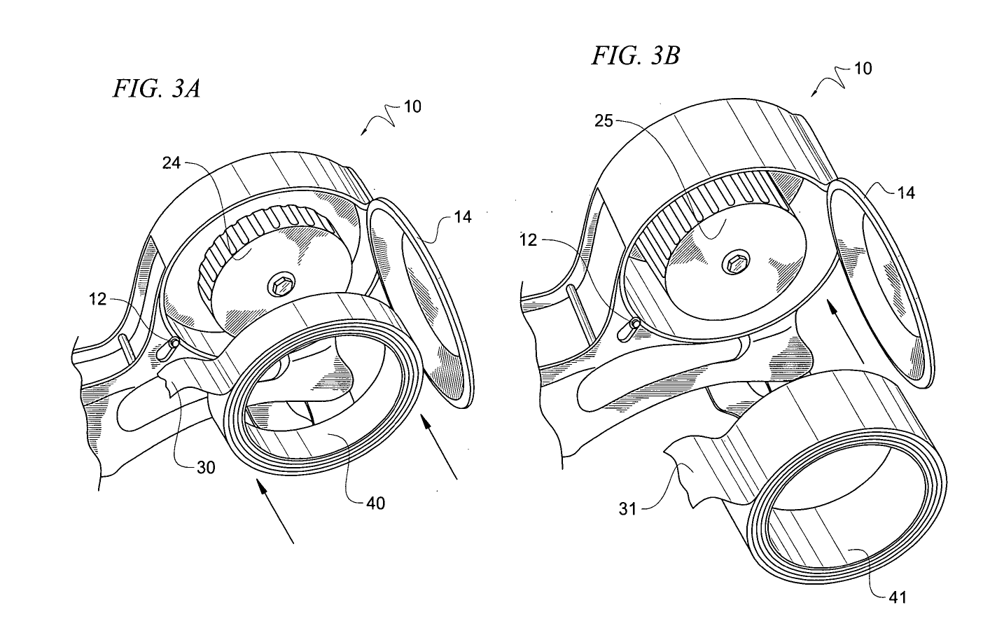

Referring now to FIG. 3a and FIG. 3b a perspective detail view of the spool of both embodiment of the present invention is shown. The tape 30/31 is provided on a supply roll 40/41. The supply roll fits snuggly on a spool 24/25, allowing it to rotate and feed the tape 30/31 through the guides 26. In some embodiments a cover 14 is included. In FIG. 3a and FIG. 3b, the cover 14 is shown open. In order to close the cover, the spring latch 12 must be pushed out of the way in order to close the cover. Although the dispenser 10 will work with any width tape that will fit within the guides, it is preferred to have a dispenser that is designed for a particular width of tape 30/31. The spool 25, trough 32, guides 26, front peripheral edge 15 and cutting edge 16 are made wider when wider tape 31 is used.

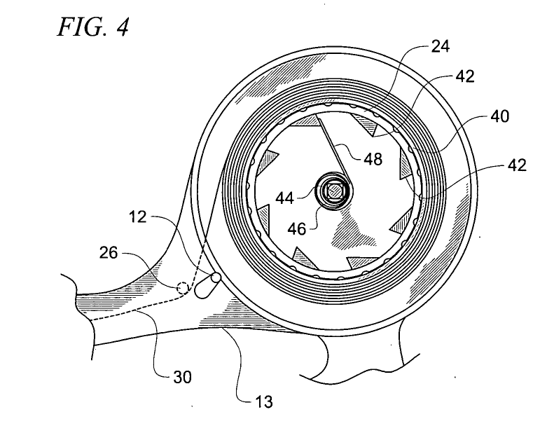

Referring now to FIG. 4 a sectional view of the spool of both embodiment of the present invention is shown. In this view, the supply roll 40 is mounted on the hub 24 and the tape 30 is threaded under a guide 26. The latch 12 is shown in the closed position. In some embodiments, the hub 24 turns freely. In the preferred embodiments, a ratchet mechanism prevents the supply roll 24 from rotating backwards, thereby pulling the tape 30 back onto the supply roll 24. The ratchet mechanism includes ratchet teeth 42 spaced about the inside surface of the hub 24. A ratchet arm 48 is spring-loaded against the teeth by a spring 46 and the spring 46 is affixed to a central shaft 44. This is just one example of a ratchet mechanism as there are many ways of restricting the direction of rotation of a hub 24 known in the art and all of such mechanisms will work equally as well in the present invention.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A forearm-mountable tape dispenser comprising:
a tape holder having a base portion shaped to conform to a forearm and support the tape holder, the base portion having a tape dispensing mechanism for dispensing tape, the tape dispensing mechanism including a hub rotatably adapted to the tape holder for holding a supply roll of the tape and the tape dispensing mechanism including a guide for delivering the tape from the supply roll to a front peripheral edge of the tape holder; and
a means to removably secure the tape holder to the forearm.

2. The forearm-mountable tape dispenser of claim 1, wherein the means to secure is one or more bendable, resilient clips.

3. The forearm-mountable tape dispenser of claim 1, wherein the means to secure is one or more straps with hook and loop fasteners, the one or more straps adapted to hold the forearm-mountable tape dispenser on the forearm.

4. The forearm-mountable tape dispenser of claim 1, further comprising a ratchet within the hub preventing the hub from retracting the tape.

5. The forearm-mountable tape dispenser of claim 1, further comprising a finger loop affixed to a bottom surface of the tape holder.

6. The forearm-mountable tape dispenser of claim 1, further comprising a door hingedly affixed to the tape holder and selectively covering the supply roll.

7. The forearm-mountable tape dispenser of claim 1, further comprising a cutting device affixed to the front peripheral edge of the tape holder.

8. A device for dispensing tape, the device comprising:
a base, the base shaped to conform to an upper surface of a human forearm;
a hub for holding a supply roll of tape, the hub rotatably coupled to the base;
a guide along the top surface of the base for delivering the tape from the supply roll to a front peripheral edge of the base; and
at least one set of straps affixed to opposite sides of the base adapted to removably affix the base to the human forearm.

9. The device for dispensing tape of claim 8, further comprising a ratchet within the hub for preventing the hub from retracting the tape.

10. The device for dispensing tape of claim 8, further comprising a finger loop affixed to a bottom surface of the base.

11. The device for dispensing tape of claim 8, further comprising a door hingedly attached to the base, the door adapted to cover the supply roll.

12. The device for dispensing tape of claim 8, further comprising a cutting device affixed to the front peripheral edge of the tape holder.

13. The device for dispensing tape of claim 8, wherein the at least one set of straps are equipped with hook and loop fasteners to removably strap the base to the human forearm.

14. A device for dispensing tape, the device comprising:
a base means;
a hub means for holding a supply roll of tape, the hub means rotatably coupled to the base means;
a guide means on a top surface of the base means, the guide means adapted to transport the tape from the supply roll to a front peripheral edge of the base means; and
a means to removably secure the base means to a human forearm.

15. The device for dispensing tape of claim 14, wherein the means to secure is one or more bendable, resilient clips.

16. The device for dispensing tape of claim 14, wherein the means to secure is one or more straps using hook and loop fasteners.

17. The device for dispensing tape of claim 14, further comprising a ratchet means adapted to the hub means for preventing the hub means from retracting the tape.

18. The device for dispensing tape of claim 14, further comprising a finger loop means affixed to a bottom surface of the base means.

19. The device for dispensing tape of claim 14, further comprising a door means hingedly attached to the base means and adapted to selectively cover the supply roll.

20. The device for dispensing tape of claim 14, further comprising a cutting means affixed to the front peripheral edge of the base means.
